(19) United States
(12) Patent Application Publication
(10) Pub. No.: US 2010/0010893 A1
(43) Pub. Date: Jan. 14, 2010

(54) VIDEO OVERLAY ADVERTISEMENT CREATOR

(75) Inventors: Shivakumar Rajaraman, San Francisco, CA (US); Jasson Arthur Schrock, Mountain View, CA (US); Matthew Liu, Fremont, CA (US)

Correspondence Address: GOOGLE / FENWICK, SILICON VALLEY CENTER, 801 CALIFORNIA ST., MOUNTAIN VIEW, CA, 94041, US

(73) Assignee: Google Inc., Mountain View, CA (US)

(21) Appl. No.: 12/170,091

(22) Filed: Jul. 9, 2008

(51) Int. Cl. G06Q 30/00; G06F 17/30

(52) U.S. Cl. 705/14.51; 707/102; 707/E17.005; 707/E17.028

(57) ABSTRACT

Methods and systems for creating video overlay advertisements suitable for use with digital videos. In one embodiment, values specifying attributes of a desired video overlay advertisement are entered via a browser-based user interface functioning on a client device and communicated to a server. The server receives the values and in response provides to the client device a video overlay advertisement having the desired attributes, which the client displays within the browser-based user interface.

### TECHNICAL FIELD

The invention relates to digital advertising, and more particularly to creating video overlay advertisements suitable for use with digital videos.

### BACKGROUND ART

The use of digital videos has grown rapidly in recent years, with video hosting web sites such as YOUTUBE now including millions of videos and having a user base of tens of millions. It would be of great benefit to those wishing to advertise their products to be able to create multimedia advertisements capable of being displayed in conjunction with these videos, thereby expanding their advertising channels. The production and use of such advertisements would also be of great value to video hosting websites and/or the authors of the videos with which the advertisements are displayed, both of whom could share in the revenues paid by the advertisers for displaying the advertisements.

Unfortunately, the conventional techniques for development of such multimedia advertisements are complex, requiring resources beyond the means of many small to medium-sized organizations. For example, multimedia advertisements are typically created using technologies such as ADOBE FLASH, which necessitates the use of multimedia development tools that can be both costly and complex. The complexity of such tools further requires personnel with the considerable development skills necessary to use the tools effectively. The net result of such a situation is that many individuals and small organizations are not able to create video-oriented advertisements, even though the use of such advertisements would be of great benefit not only to themselves, but also to the video hosting sites and video authors.

### SUMMARY

Described embodiments of the present invention enable the creation of video overlay advertisements in which the description of an advertisement is reduced to a small set of attributes easily specifiable via a convenient browser-based interface, and the resulting advertisement is stored within a remote advertisement database.

In one embodiment, an advertisement creation server includes an advertisement creation module used to create an advertisement based on specified attributes, a template database having templates upon which the created advertisement is based, and an advertisement database storing the created advertisement. In one embodiment, values specifying attributes of a desired video overlay advertisement are entered via a browser-based user interface functioning on a client device and communicated to the advertisement creation server's advertisement creation module. The advertisement creation server receives the values and in response creates and provides to the client device a video overlay advertisement having the desired attributes, which the client displays within the browser-based user interface. In one embodiment, the browser-based user interface displays multiple advertisement segments, each segment having attributes representing the appearance of the advertisement at a particular point in time, and a set of transitions between the segments. In one embodiment, the browser-based user interface includes controls for specifying the actions that are taken in response to selection of the advertisement.

The features and advantages described in this summary and the following detailed description are not all-inclusive. Many additional features and advantages will be apparent to one of ordinary skill in the art in view of the drawings, specification and claims hereof.

### BRIEF DESCRIPTION OF THE DRAWINGS

FIG. 1A is a block diagram of the system architecture of one embodiment of the present invention.

FIG. 1B is a block diagram describing the architecture of an advertisement creation server according to one embodiment.

FIGS. 2A and 2B illustrate an example of an advertisement creation user interface for creating multimedia advertisements according to one embodiment.

FIG. 3 is a flowchart illustrating a method for creating multimedia advertisements according to one embodiment.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

### System Architecture

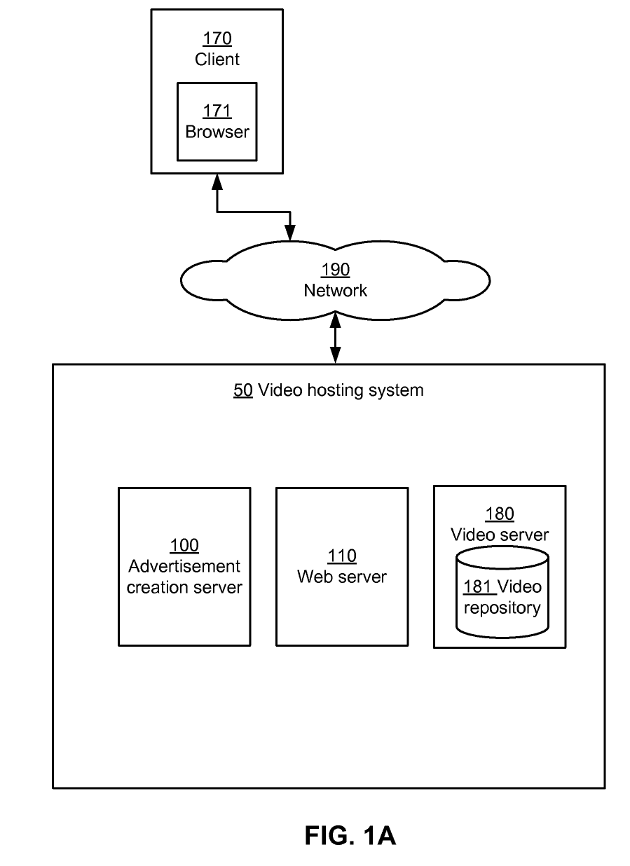

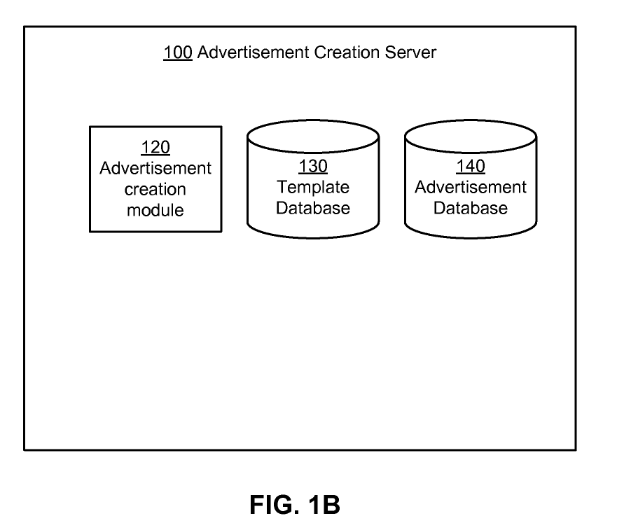

FIG. 1A is a high-level block diagram of a system architecture according to one embodiment. FIG. 1A illustrates a client device 170 and a video hosting system 50 connected by a network 190. Only one client device 170 and one advertisement creation server 100, web server 110, and video server 180 are shown in FIG. 1A in order to simplify and clarify the description. Embodiments of the computing environment can have multiple advertisement creation servers 100, video servers 180, web servers 110, and clients 170 connected to the network 190. Certain functionality described in one embodiment as being performed on the server side can also be performed on the client side in other embodiments if appropriate. In addition, the functionality attributed to a particular component can be performed by different or multiple components operating together.

The client device 170 executes a browser 171 and can connect to the video hosting system 50 via a network 190, which is typically the Internet, but can also be any network, including but not limited to any combination of a LAN, a MAN, a WAN, a mobile, wired or wireless network, a private network, or a virtual private network. While only a single client device 170 and browser 171 are shown, it is understood that very large numbers (e.g., millions) of clients are supported and can be in communication with the video hosting system 50 at any time. The client device 170 may include a variety of different computing devices. Examples of client devices 170 are personal computers, digital assistants, personal digital assistants, cellular phones, mobile phones, smart phones or laptop computers. As will be obvious to one of ordinary skill in the art, the present invention is not limited to the devices listed above.

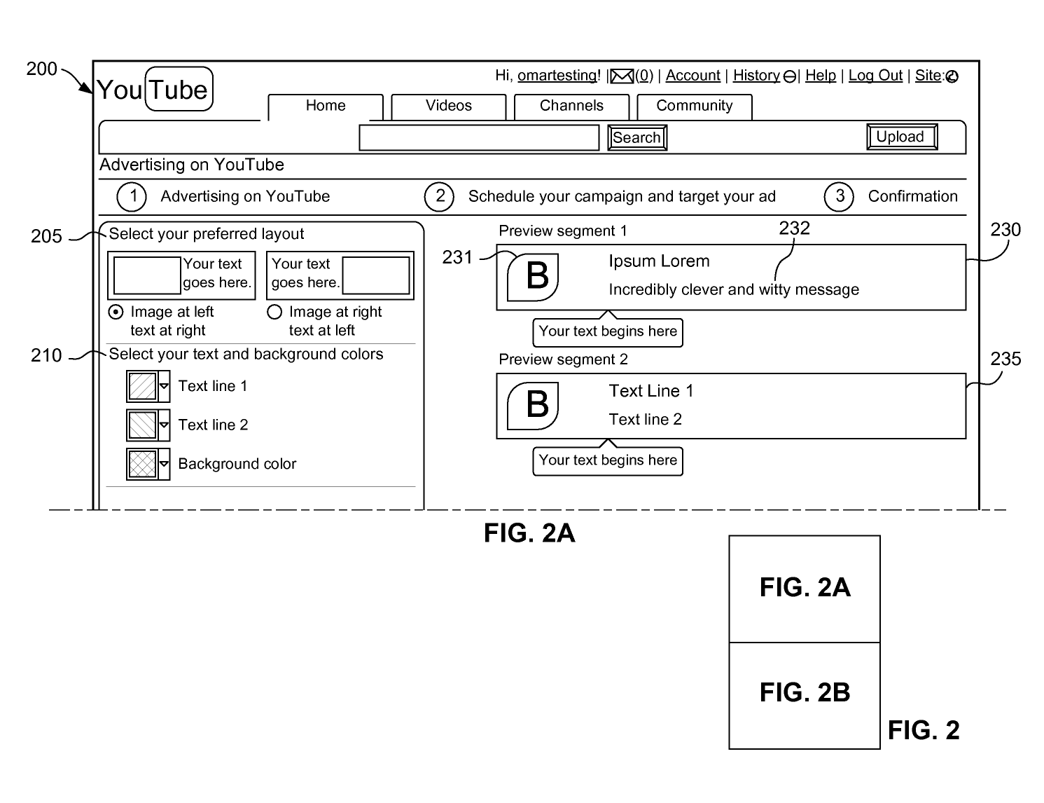

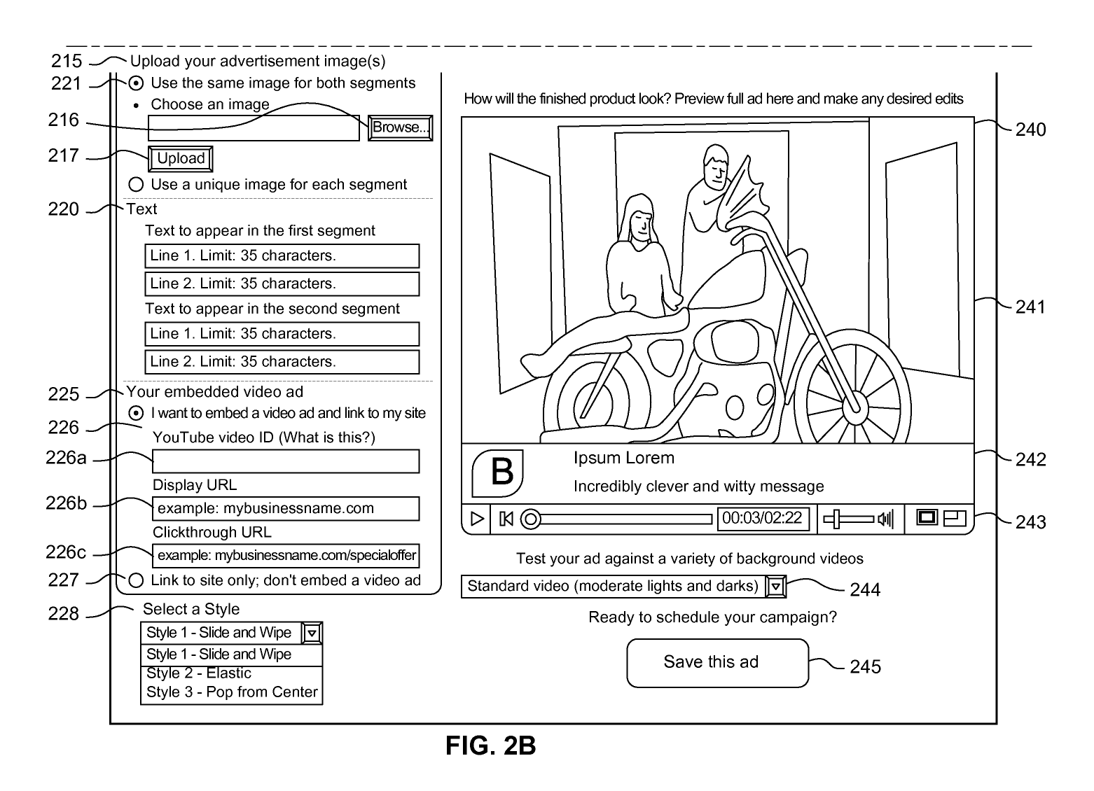

The browser 171 displays an advertisement creation user interface specified by the web server 110, such as the user interface 200 described below with respect to FIG. 2. The browser 171 can further include a video player (e.g., FLASH from Adobe Systems, Inc.), or any other player adapted to display the multimedia advertisement generated based on the input specified via the advertisement creation user interface. For example, a dynamic preview area such as that described below with respect to FIG. 2 can be implemented using such a player, e.g. as a plug-in to the browser 171.

The web server 110 is a module providing web-based user interfaces for interacting with the advertisement creation server 100 and/or the video server 180. For example, the web server 110 provides the advertisement creation user interface used for creating the multimedia advertisement, such as the user interface 200 discussed below with respect to FIG. 2, and the user interfaces for requesting a given video from the video server 180 and for viewing the video once it is provided. The web server 110 may be implemented by conventional web server software, such as APACHE or INTERNET INFORMATION SERVICES. In one embodiment, the web server 110 generates the advertisement creation user interface dynamically based on attributes specific to a user, such as how the user has previously used the interface. Alternatively, the initial advertisement creation user interface may be generated statically, creating the same advertisement creation user interface for all users.

The video server 180 illustrates a server system capable of providing videos. The video server 180 includes a video repository 181 storing videos. Upon request for a given video, e.g. a video in the video repository 181, the video server 180 provides the requested video. The video repository 181 stores the videos in association with various related information. For example, one type of related information that can be associated with a video is category and/or keyword information describing the subject matter of the video, e.g. the category “Autos & Vehicles” for a video related to a motorcycle, or the keywords “Mediterranean” and “vacation” for a video about traveling in Greece.

As illustrated in FIG. 1B, in one embodiment the advertisement creation server 100 comprises a template database 130, an advertisement database 140, and an advertisement creation module 120. These components are described in greater detail below. Note that the advertisement creation server 100 may be provided by the operator of the video server 180, or it may be provided by a third party, either independently or on behalf of the video server 180.

The template database 130 stores a set of templates for creating multimedia advertisements. A template lacks information specific to a particular advertisement but provides basic structure and rules usable by all advertisements created by the advertisement creation server 100. For example, a template could define a particular size and shape for the region occupied by an advertisement, a set of text and/or image segments and a timespan over which a transition will transform one segment into the next, a textual caption and its location (e.g. the string “Advertisement” placed in the lower-right corner of the region), and an image and location of a close box associated with the advertisement and its associated behavior (e.g. a close box located in the upper-right corner of the region that, when activated, causes the advertisement to be hidden). As another example, a template could be visually blank, not defining the visual location or size of the advertisement, but specifying advertisement actions to be taken, e.g. a particular transition to be used between portions of the advertisement. In one embodiment, advertisements are specified using FLASH technology, and templates for such advertisements are likewise specified using FLASH code. It is appreciated, however, that a wide range of alternate methods of, and technologies for, implementing an advertisement and/or a template upon which the advertisement is based, are equally possible.

In one embodiment, the template database 130 stores only one template applicable to all users. In another embodiment, the template database 130 stores multiple distinct templates among which users may choose. For example, different templates could have different advertisement region sizes, different possible visual components (e.g. text and images), different numbers of segments, different available colors and transitions, etc. In one embodiment, users may customize and submit templates for storage in the template database 130, either for their own private use or for the use of others. A user interface such as that of FIG. 2 (discussed below) will reflect only a single template at any given time for a given user; this template is referred to hereinafter as the “selected” template for the given user.

Finished advertisements, as well as those currently in the process of being created, are stored in the advertisement database 140. In one embodiment, such an advertisement is stored in association with a unique identifier for the user that created it, e.g., a username used by the user to log into the advertisement creation server 100, or an email address of the user. In a further embodiment, the advertisement is stored in further association with a set of criteria, such as keywords or phrases specifying subject matter relevant to the advertisement (e.g. “motorcycles” or “Mediterranean vacation”), used to determine whether to display the advertisement along with a given video.

The advertisement creation module 120 receives user input and produces a multimedia advertisement based on the received input and on the applicable template from the template database 130. For example, in one embodiment the advertisement creation user interface produced by the web server 110 is specified in HTML, and specified parameters are provided by the client web browser 171 to the advertisement creation module 120 via a string obtained using the HTTP GET or POST methods. In other embodiments, the parameters are passed via JavaScript to the HTML page creating the user interface, or sent to a Flash module at the time of page creation via FlashVars parameters. In one embodiment, the first time that a user indicates an interest in creating a new advertisement, such as by navigating to a “Create your ad” link on a web page generated by web server 110, the advertisement creation module 120 creates a new advertising document that incorporates the material of the selected template. Then, when a user specifies any advertisement-specific information, the advertisement creation module 120 proceeds to update the advertising document by adding to or modifying its content in accordance with the specified information. In different embodiments, such an update can take place either all at once, or incrementally. For example, in one embodiment the update could take place only after the user has activated a save button, at which point the browser could provide to the advertisement creation module 120 the data on all the user interface elements for which values have been specified, and the advertisement creation module 120 could then add or substitute those values into the advertising document. The advertisement creation module 120 can accomplish this addition or substitution in different ways in different embodiments. For example, in an embodiment in which the user interface is specified at least in part using the JavaScript scripting language and the template is specified at least in part using FLASH code including FLASH objects, the data for the user interface elements with specified values could be added or substituted into the advertising document in different ways. One way could be passing the data via a JavaScript call to a FLASH object. Another way could be passing the data to a FLASH LoadVars object or loadVariables action at page creation. If the user interface was specified in FLASH rather than in a language such as JavaScript, the data could be handled natively within FLASH.

In another embodiment in which more immediate feedback is provided, such an update could take place for each applicable user input event. For example, as the user types text into a text field corresponding to an advertisement caption, an advertisement preview area can be updated in real time to display the advertisement, including the current value of the caption. This can accomplished by, for example, event handlers of JavaScript, or other scripting language used to implement the advertisement creation user interface, reacting to the typing of keystrokes into the text field by reading the current value of the field, causing an update of the advertising document using that value, and updating the user interface to reflect the updated contents of the advertising document.

### Example User Interface

FIGS. 2A and 2B illustrate an example of an advertisement creation user interface 200 for creating video overlay advertisements according to one embodiment. In one embodiment, the user interface 200 is provided by the web server 110 and displayed within the browser 171 of the client device 170. The advertisement creation user interface 200 comprises interface elements 205-228 for specifying the properties of the desired advertisement, including its text, images, colors, and transition effects between different segments of the advertisement, and interface elements 230-244 for previewing the resulting advertisement. In this particular example, the advertisement consists of two segments, the first segment transitioning into the second segment over time.

More specifically, layout controls 205 allow a user to specify how the various elements of the advertisement are placed with respect to each other—in the example of FIG. 2, this comprises specifying how the text is horizontally situated with respect to the images. Color controls 210 allow the user to specify the colors of the advertisement, including the color of the background and the color of the first and second lines of the specified text.

Image controls 215 contains controls allowing the user to specify the image or images displayed in the advertisement. For example, the first selection button 221 specifies whether a single image is used, or whether each of the two segments in the advertisement has its own image. The browse button 216 and upload button 217 enable a user to identify an image file accessible to a client device, and to transfer it to advertisement creation server 100 for incorporation in the generated video overlay advertisement. Text controls 220 allow the user to specify the textual elements of the video overlay advertisement. In this particular example, the textual elements for each of two segments are further broken down into a first line and a second line.

Associated advertisement description controls 225 allow the user to specify the actions to be taken when a viewer of the advertisement clicks on or otherwise selects it. Selection of the first option 226 specifies the playing of a further video advertisement. In one embodiment, the further video advertisement to be played is uniquely specified with a video identifier (e.g. an alphanumeric string such as “He7Ge7Sogrk”) as provided in the first text field 226a. The display URL and clickthrough URL of text fields 226b and 226c specify, respectively, the uniform resource locator (URL) displayed along with the advertisement, and the URL of a page that a viewer will be referred to upon clicking on the displayed link. Alternatively, selection of the second option 227 specifies that a web site should be linked to, but that no video should be played.

Style selection control 228 allows the user to specify the graphical transition that takes place between the first and the second segment when the video overlay advertisement is displayed. In the example, the user has chosen a “Slide and Wipe” transition that causes the text and graphics from the second segment to appear to slide from right to left and to displace the text and graphics from the first segment.

Interface elements 205-228 specify attributes of the desired advertisement, and preview areas 230-240 accordingly display an advertisement having those attributes. The segment preview areas 230 and 235 display, in static fashion, the final appearance of the first advertisement segment and the second advertisement segment, respectively, using the layout, colors, images, and text specified by user interface elements 205-220. For example, image area 231 of segment preview area 230 displays the image specified using image controls 215. Likewise, text area 232 displays the two text lines specified using text controls 220.

Dynamic preview area 240, which includes a video play area 241 and an advertisement preview area 242, allows the user to view the video overlay advertisement in real time, as it transitions from the first segment to the second segment in conjunction with the playing of a video (the transitioning hereinafter referred to as “playing” the video overlay advertisement). The video play area 241 plays a video, and the advertisement preview area 242 plays the generated video overlay advertisement as it transitions between the first and the second segment. This allows the user to evaluate the appearance of the video overlay advertisement with respect to a given video. The particular video displayed in video play area 241 is determined according to the desired video attributes specified using video selection list 244. In the example of FIG. 2, the user has specified that a standard video with moderate light and dark colors should be displayed. Videos with different visual impressions can also be selected, such as videos with primarily dark colors, videos with primarily light colors, videos with visual transitions that are particularly frequent or infrequent, and the like. Video playback controls area 243 contains conventional controls for video playback, with the difference that the controls simultaneously determine the playback of both the video displayed in video play area 241 and the video overlay advertisement displayed in advertisement preview area 242.

Finally, the save button 245 allows a user to indicate that the advertisement is complete, and that the user is ready to end the advertisement creation process and to take a further associated action, if any.

In one embodiment, the advertisement creation user interface 200 is specified using HyperText Markup Language (HTML) and a client-side scripting language such as JavaScript, though many other implementations are equally possible. In such an embodiment, the advertisement creation user interface 200 can be made more responsive through the use of the scripting language. For example, JavaScript event handling code associated with text controls 220 can intercept keystrokes as the user types them and incrementally incorporate the typed characters into the advertisement, thus updating the generated video overlay advertisement, and displaying it in the preview areas 230-240, in real time.

The user interface 200 of FIG. 2 represents merely one embodiment of the advertisement creation user interface. It is appreciated that many other variations could equally be possible. For example, the particular user interface elements could vary in contents, behavior, and location. As another example, advertisements could have multiple segments, or just one.

### Advertisement Creation Method

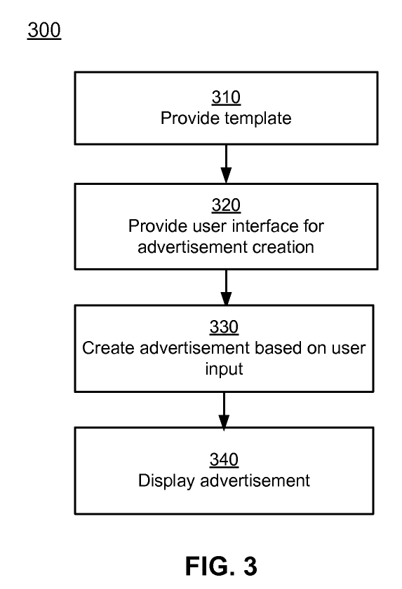

Referring now to FIG. 3, there is shown a flowchart illustrating a method 300 for creating video overlay advertisements according to one embodiment. First, a template is provided 310. This is accomplished, for example, by creating a template and storing it within the template database 130 on the advertisement creation server 100. The template may be created, for example, by an owner or operator of the advertisement creation server 100. Alternatively, the template can be created and submitted by users of the advertisement creation server 100.

An advertisement creation user interface is then provided 320 for advertisement creation. FIGS. 2A and 2B, discussed above, depict one example of such a user interface. The advertisement creation user interface is generated by code of web server 110. As previously noted, the advertisement creation user interface 200 can be based on the template: for example, the number of segments for which attributes are to be provided can be based on examination of how many segments are defined within the template. Further, as noted the advertisement creation user interface 200 can be statically or dynamically generated by web server 110.

Next, an advertisement is created 330 based on user input provided via the advertisement creation user interface. As described above with respect to the advertisement creation module 120, a desired advertisement is embodied in an advertising document that is based on the selected template, and the provided user input is incorporated into the advertising document, either incrementally or all at once. When a user indicates that the advertisement is complete, e.g. by selecting the save button 245 of FIG. 2, then the advertisement is marked within the advertisement database 140 as being completed and ready for use. The advertisement may be stored FLASH SWF format, but in may also be stored in different formats in different embodiments, such as MP4 video, AVI, MPEG, QuickTime, and the like.

Finally, the created advertisement is displayed 340. Display can be interleaved with the creation process, such as by dynamically updating preview areas 230-240 as a user specifies the advertisement attributes. Alternatively, the advertisement can be displayed only at the end of the process.

After the advertisement is created 330, further data may be provided regarding the advertisement and/or its uses. One such type of data specifies conditions under which the advertisement will be displayed along with a video, and may be specified in a user interface separate from the advertisement creation user interface. Examples of such conditions include a maximum number of times that the advertisement will be displayed and locations in association with which it will be displayed. Another example of such conditions includes the desired type of videos with which the advertisement will be displayed. One embodiment also allows a user to specify whether the overlay advertisement is displayed with videos on a shared video site, with videos on an embedded video player, or both. The desired video type may be specified by user-specified keywords (e.g. “motorcycle”), or by a general category (e.g. “Autos & Vehicles”), for example, such keywords/categories taken from the set that is assignable to videos of the video repository 181. Thus, when the video server 180 provides a video to a user, whether or not the advertisement is a candidate for display can be determined with reference to the keywords/categories assigned to the provided video and to the advertisement, which matches indicating that the advertisement is a candidate. Another embodiment allows a user to specify the manner in which the advertisement should be overlaid on any video with which it is associated, such as by compressing the content video frame and displaying the advertisement in the remainder of the frame, as depicted in the dynamic preview area 240 of FIG. 2, or by compositing it on top of a content video frame.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described. Also, the particular division of functionality between the various system components described herein is merely exemplary, and not mandatory; functions performed by a single system component may instead be performed by multiple components, and functions performed by multiple components may instead performed by a single component.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for creating a video overlay advertisement for display with a digital video, the method comprising:
providing a browser-based user interface to a client, the user interface including an advertisement viewing area and adapted to receive inputs specifying attribute values of a desired video overlay advertisement;
receiving the specified attribute values from the client;
creating a video overlay advertisement having the specified attribute values;
storing the video overlay advertisement; and
providing the video overlay advertisement to the client.

2. The method of claim 1, further comprising receiving attributes of digital videos in association with which to display the advertisement.

3. The method of claim 1, wherein the advertisement viewing area comprises an area for viewing playback of the video overlay advertisement, an area for viewing playback of a digital video, and video playback controls for simultaneously controlling playback of both the digital video and the video overlay advertisement.

4. The method of claim 1, wherein the advertisement viewing area comprises an area displaying a static representation of the video overlay advertisement.

5. The method of claim 1, wherein the values that specify attributes of the desired video overlay advertisement comprise at least one value for specifying a first advertisement segment, at least one value for specifying a second advertisement segment, and at least one value for specifying a transition between the first advertisement segment and the second advertisement segment.

6. The method of claim 5, wherein the at least one value for specifying a first advertisement segment comprises one or more of a value specifying a textual message and a value specifying an image, and wherein the at least one value for specifying a second advertisement segment comprises one or more of a value specifying a textual message and a value specifying an image.

7. The method of claim 1, wherein the values that specify attributes of a desired video overlay advertisement comprise at least one value specifying an advertising action to be taken when the video overlay advertisement is selected by a user.

8. The method of claim 7, wherein the advertising action comprises playing a digital video related to the video overlay advertisement.

9. The method of claim 1, wherein the created video overlay advertisement additionally has default attributes specified by a template received from a second client.

10. The method of claim 1, where the digital video is a video played on an embedded video player.

11. The method of claim 1, where the digital video is a video played on a video sharing site.

12. The method of claim 1, wherein the video overlay advertisement is passed to the client as data in the Flash format, separate from the digital video with which it is displayed.

13. A computer-readable storage medium storing a computer program executable by a processor for creating a video overlay advertisement for display with a digital video, the video hosting service storing a plurality of videos in a video database, the actions of the computer program comprising:
providing a browser-based user interface to a client, the user interface including an advertisement viewing area and adapted to receive inputs specifying attribute values of a desired video overlay advertisement;
receiving the specified attribute values from the client;
creating a video overlay advertisement having the specified attribute values;
storing the video overlay advertisement; and
providing the video overlay advertisement to the client.

14. The computer-readable storage medium of claim 13, the actions of the computer program further comprising receiving attributes of digital videos in association with which to display the advertisement.

15. The computer-readable storage medium of claim 13, wherein the advertisement viewing area comprises an area for viewing playback of the video overlay advertisement, an area for viewing playback of a digital video, and video playback controls for simultaneously controlling playback of both the digital video and the video overlay advertisement.

16. The computer-readable storage medium of claim 13, wherein the advertisement viewing area comprises an area displaying a static representation of the video overlay advertisement.

17. The computer-readable storage medium of claim 13, wherein the values that specify attributes of the desired video overlay advertisement comprise at least one value for specifying a first advertisement segment, at least one value for specifying a second advertisement segment, and at least one value for specifying a transition between the first advertisement segment and the second advertisement segment.

18. The computer-readable storage medium of claim 17, wherein the at least one value for specifying a first advertisement segment comprises one or more of a value specifying a textual message and a value specifying an image, and wherein the at least one value for specifying a second advertisement segment comprises one or more of a value specifying a textual message and a value specifying an image.

19. The computer-readable storage medium of claim 13, wherein the values that specify attributes of a desired video overlay advertisement comprise at least one value specifying an advertising action to be taken when the video overlay advertisement is selected by a user.

20. The computer-readable storage medium of claim 19, wherein the advertising action comprises playing a digital video related to the video overlay advertisement.

21. The computer-readable storage medium of claim 13, wherein the created video overlay advertisement additionally has default attributes specified by a template received from a second client.

22. A computer-implemented system for creating a video overlay advertisement for display with a digital video, the system comprising:
a template database adapted to store a set of templates for creating video overlay advertisements;
an advertisement database adapted to store advertisements; and
an advertisement creation module executed by the computer and adapted to:
provide a browser-based user interface to a client, the user interface including an advertisement viewing area and adapted to receive inputs specifying attribute values of a desired video overlay advertisement;
receive the specified attribute values from the client;
create a video overlay advertisement having the specified attribute values;
store the video overlay advertisement in the advertisement database; and
provide the video overlay advertisement to the client.

23. The computer-implemented system of claim 22, the advertisement creation module further adapted to receive attributes of digital videos in association with which to display the advertisement.

24. The computer-implemented system of claim 22, wherein the advertisement viewing area comprises an area for viewing playback of the video overlay advertisement, an area for viewing playback of a digital video, and video playback controls for simultaneously controlling playback of both the digital video and the video overlay advertisement.

25. The computer-implemented system of claim 22, wherein the advertisement viewing area comprises an area displaying a static representation of the video overlay advertisement.

26. The computer-implemented system of claim 22, wherein the values that specify attributes of the desired video overlay advertisement comprise at least one value for specifying a first advertisement segment, at least one value for specifying a second advertisement segment, and at least one value for specifying a transition between the first advertisement segment and the second advertisement segment.

27. The computer-implemented system of claim 26, wherein the at least one value for specifying a first advertisement segment comprises one or more of a value specifying a textual message and a value specifying an image, and wherein the at least one value for specifying a second advertisement segment comprises one or more of a value specifying a textual message and a value specifying an image.

28. The computer-implemented system of claim 22, wherein the values that specify attributes of a desired video overlay advertisement comprise at least one value specifying an advertising action to be taken when the video overlay advertisement is selected by a user.

29. The computer-implemented system of claim 28, wherein the advertising action comprises playing a digital video related to the video overlay advertisement.

30. The computer-implemented system of claim 22, wherein the created video overlay advertisement additionally has default attributes specified by a template from the template database, the template having been received from a second client.

31. A method for creating a video overlay advertisement for display with a digital video, the method comprising:
receiving a browser-based user interface from a server, the user interface including an advertisement viewing area and adapted to receive inputs specifying attribute values of a desired video overlay advertisement;
providing, to the server, inputs specifying the attribute values of the desired video overlay advertisement; and
receiving a video overlay advertisement from the server, the received video overlay advertisement having the specified attributes;
wherein the advertisement viewing area comprises an area for viewing playback of the video overlay advertisement, an area for viewing playback of a digital video, and video playback controls for simultaneously controlling playback of both the digital video and the video overlay advertisement.

32. The method of claim 31, further comprising providing, to the server, attributes of digital videos in association with which to display the advertisement.

33. The method of claim 31, wherein the advertisement viewing area further comprises an area displaying a static representation of the video overlay advertisement.

34. The method of claim 31, wherein the values that specify attributes of the desired video overlay advertisement comprise at least one value for specifying a first advertisement segment, at least one value for specifying a second advertisement segment, and at least one value for specifying a transition between the first advertisement segment and the second advertisement segment.

35. The method of claim 34, wherein the at least one value for specifying a first advertisement segment comprises one or more of a value specifying a textual message and a value specifying an image, and wherein the at least one value for specifying a second advertisement segment comprises one or more of a value specifying a textual message and a value specifying an image.

36. The method of claim 31, wherein the values that specify attributes of a desired video overlay advertisement comprise at least one value specifying an advertising action to be taken when the video overlay advertisement is selected by a user.

37. The method of claim 36, wherein the advertising action comprises playing a digital video related to the video overlay advertisement.

38. The method of claim 31, wherein the received video overlay advertisement additionally has default attributes specified by a template provided by a second client.

39. The method of claim 31, where the digital video is a video played on an embedded video player.

40. The method of claim 31, where the digital video is a video played on a video sharing site.

41. The method of claim 31, wherein the video overlay advertisement is received by the client in the Flash format, separate from the digital video with which it is displayed.
